(19) United States
(12) Patent Application Publication
(10) Pub. No.: US 2005/0138184 A1
(43) Pub. Date: Jun. 23, 2005

(54) Efficient method for sharing data between independent clusters of virtualization switches

(75) Inventor: Shai Amir, Raonana (IL)

Correspondence Address: KATTEN MUCHIN ZAVIS ROSENMAN, 575 MADISON AVENUE, NEW YORK, NY, 10022-2585, US

(73) Assignee: SANRAD LTD.

(21) Appl. No.: 11/016,100

(22) Filed: Dec. 17, 2004

Related U.S. Application Data
(60) Provisional application No. 60/531,228, filed on Dec. 19, 2003.

(51) Int. Cl. G06F 12/00

(52) U.S. Cl. 709/228

(57) ABSTRACT

A method for sharing data between independent clusters of virtualization switches is provided. The method allows an initiator host to read data directly through a single virtualization switch without transferring data between independent virtualization switches.

The present application claims the benefit under 35 U.S.C. § 119(e) of U.S. Provisional Application No. 60/531,228, filed on Dec. 19, 2003.

### TECHNICAL FIELD

The present invention relates generally to storage area networks (SANs), and more particularly to the exchanging of data between independent storage networks connected in the SANs.

### BACKGROUND OF THE INVENTION

The rapid growth in data intensive applications continues to fuel the demand for raw data storage capacity. As a result, there is an ongoing need to add more storage, file servers, and storage services to an increasing number of users. To meet this growing demand, the concept of a storage area network (SAN) was introduced. A SAN is defined as a network having a primary purpose of transferring data between computer systems and storage devices. In a SAN environment, storage devices and servers are generally interconnected via various switches and appliances. This structure generally allows for any server on the SAN to communicate with any storage device and vice versa. It also provides alternative paths from a server to a storage device to ensure that the system is fault tolerant.

To increase the utilizations of SANs, extend the scalability of storage devices, and increase the availability of data, the concept of storage virtualization was recently developed. Storage virtualization offers the ability to isolate a host from changes in the physical placement of storage. The result is a substantial reduction in support effort and end-user impact.

A SAN enabling storage virtualization operation typically includes one or more virtualization switches. A virtualization switch is connected to a plurality of hosts through a network, such as a local area network (LAN) or a wide area network (WAN). The connections formed between the hosts and the virtualization switches can utilize any protocol including, but not limited to, Gigabit Ethernet carrying packets in accordance with the internet small computer systems interface (iSCSI) protocol, Infiniband protocol, and others. A virtualization switch is further connected to a plurality of storage devices through a storage connection, such as Fiber Channel (FC), parallel SCSI (pSCSI), iSCSI, and the likes. A storage device is addressable using a logical unit number (LUN). LUNs are used to identify a virtual volume that is presented by a storage subsystem or network device and specified in a SCSI command and as configured by a user (e.g., a system administrator).

iSCSI allows the execution of SCSI data requests, date transmission and data reception, over internet protocol (IP) network. iSCSI is based on the existing SCSI standards currently used for communication among servers and their attached storage devices. FIG. 1 illustrates an iSCSI protocol layering model. In a SAN supporting iSCSI protocol, an initiator 110 (e.g., a host or a software application executed by the host) issues a SCSI command to store or retrieve data on a storage device. The request is processed by the operating system (OS) and is converted to one or more SCSI commands 111 that are then passed to an application program or to a card, e.g., a network interface card (NIC). The command and data are encapsulated by representing them as a serial string of bytes proceeded by iSCSI headers 112. The encapsulated data is then passed to a TCP/IP layer 113 that breaks the encapsulated data into packets suitable for transfer over network 130. At the target side 120, i.e., a storage device, the packets are recombined by TCP/IP layer 123 into the original encapsulated SCSI commands 121 and data. The storage controller then uses the iSCSI headers 122 to send the SCSI control commands and data to the appropriate driver, which performs the functions that were requested by the initiator 110. If a request for data was sent, the data is retrieved from a storage driver, encapsulated and returned to the initiator 110. The entire process is transparent to the user.

In a SAN having more than one virtualization switch, storage devices that are connected to a virtualization switch are considered as an independent storage network, i.e., a storage device cannot be connected to two different virtualization switches. The connectivity limitation results from the number of interfaces of each virtualization switch as well as bandwidth limitation. Thus, a host cannot read or write data from two different storage networks in one pass. This significantly limits the performance of the SAN.

Therefore, it would be advantageous to provide a method that allows the exchange of data between independent storage networks connected to independent virtualization switches. It would be further advantageous if the provided method operates without transferring data between the virtualization switches connected to those storage networks.

### BRIEF DESCRIPTION OF THE DRAWINGS

FIG. 1—is an illustration of an iSCSI protocol layering model

FIG. 2—is an exemplary diagram of a storage area network (SAN) for the purpose of illustrating the principles of the present invention

FIG. 3—is an example for the operation of the disclosed invention

FIG. 4—is an exemplary data packet with requisite headers before being transmitted on the network

FIG. 5—is a non-limiting and exemplary flowchart describing the method for reading data spread over a plurality of independent storage networks

FIG. 6—is an exemplary representation of a header data structure (HDS) according to an embodiment of this invention

FIG. 7—is a non-limiting and exemplary flowchart describing the method for writing data to a plurality of logical units connected to a plurality of independent storage networks

FIG. 8—is non-limiting of diagram of a scalable storage area network topology

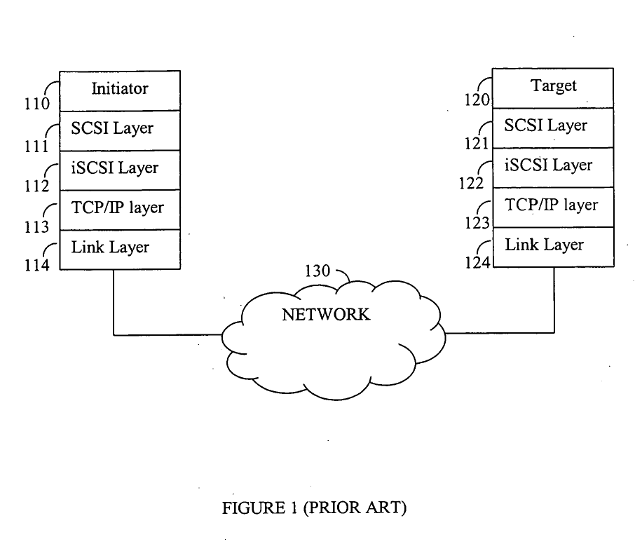

### DESCRIPTION OF THE INVENTION

The present invention discloses a method for sharing data between independent clusters of virtualization switches. The method allows an initiator host to read data directly through a single virtualization switch without transferring data between independent virtualization switches.

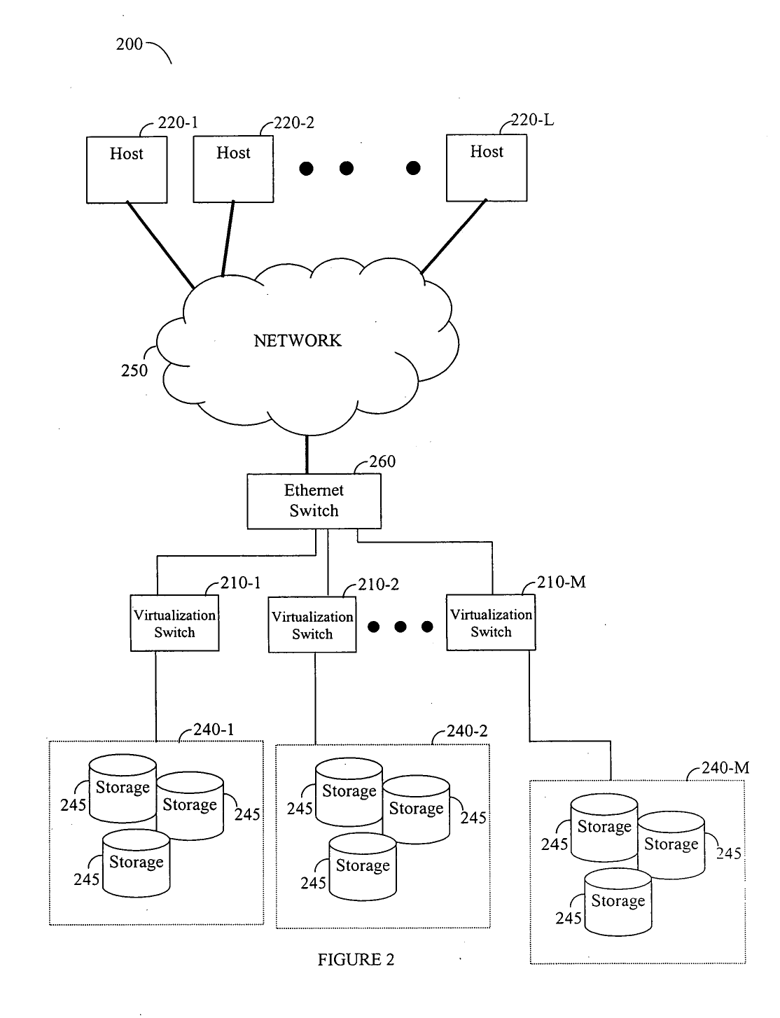

Referring to FIG. 2 an exemplary diagram of a storage area network (SAN) 200 used for illustrating the principles of the present invention is shown. SAN 200 comprises N independent virtualization switches 210-1 through 210-n. Each virtualization switch 210 is connected to a storage network 240. In one embodiment, a cluster of virtualization switches may be connected to a storage network 240 through a fiber channel (FC) switch. Hosts 220 communicate with virtualization switches 210 through network 250. Network 250 may be, but is not limited to, a local area network (LAN) or wide area network (WAN). The connections formed between the hosts 220 and virtualization switches 210 can utilize any protocol including, but not limited to, Gigabit Ethernet carrying packets in accordance with the iSCSI protocol. The connections are routed to virtualization switches 210 through an Ethernet switch 260. A virtualization switch 210 is further connected to a plurality of storage devices through a storage connection, such as Fiber Channel (FC), parallel SCSI (pSCSI), iSCSI, and the likes. The communications can be utilized using pSCSI protocol, iSCSI protocol, FC protocol, and the likes. A storage network 240 includes a plurality of storage devices 245. Storage devices 245 may include, but are not limited to, tape drives, optical drives, disks, and redundant array of independent disks (RAID).

Other topologies of SAN 200 may be recognized by a person skilled in the art. For example, virtualization switches 210, connected to LANs, may be geographically distributed. As for another example, virtualization switches 210 may be connected to a storage network through an IP-SAN or FC-SAN.

Each virtualization switch 210 includes a mapping table that allows data sharing among independent storage networks 240. The mapping table includes mapping information specifying virtualization address spaces accessed by each virtualization switch 210 connected in SAN 200. The mapping information allows hosts 220 request for data, transmission and reception from storage networks 240-1 through 240-M via a single virtualization switch 210. Moreover, the mapping information allows host 220 to treat all storage devices 245, connected in SAN, as a single storage network 240. The content of the mapping table is preconfigured and updated automatically.

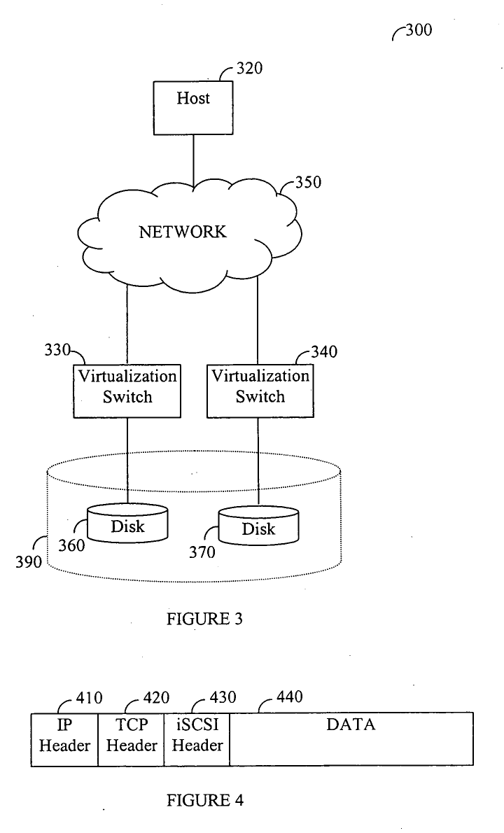

Referring to FIG. 3, an example for the operation of the disclosed invention is provided. FIG. 3 shows a non-limiting diagram of a simple SAN 300 comprising of a single host 320, a communication network 350, and two independent virtualization switches 330 and 340. Virtualization switches 330 and 340 are connected to disks 360 and 370 respectively. In this example, a virtual volume 390 is configured as a concatenation of two logical units (LUs), e.g., disks 370 and 360. A LU is defined as a plurality of continuous data blocks having the same block size. The virtual address space of a virtual volume resides between ‘0’ to the maximum capacity of the data blocks defined by the LUs. LUs and virtual volumes have the same virtual address spaces. For instance, the virtual address space of the virtual volume 390 is 0-1000. Given that the virtual volume 390 is a concatenation of LUs 360 and 370, the address spaces of LUs 360 and 370 are 0000-0500 and 0000-0500. The physical address spaces of the storage occupied by LUs 360 and 370 is denoted by the physical address of the data blocks, however, the capacity of the storage occupied by these LUs is at most 1000 blocks.

If host 320 initiates a request to read the entire content of virtual volume 390, then a read SCSI command is sent to virtualization switch 330. The read SCSI command includes the LUN (i.e., the logical number of LU 390), an initiator tag, and the expected data to be transferred. Subsequently, virtualization switch 330 parses the command and retrieves the data resided in LU 360 i.e., data resided in the virtual address space 0-500. To retrieve the data stored in LU 370, virtualization switch 330 searches in the mapping table for a virtualization switch that has access to LU 370, i.e., virtualization switch 340. Virtualization switch 340 retrieves the data from LU 370 and transfers the retrieved data to host 320. The data transmission must be transparent to the initiator host 320, That is, host 320 should not actualize that part of the data was transferred from LU 370 via virtualization switch 340. If this requirement is not served, then the operation may fail.

A straightforward approach is to transfer the data through virtualization switch 330. This approach takes the following steps:
a) virtualization switch 330 instructs virtualization switch 340 to retrieve the data form LU 370;
b) virtualization switch 340 retrieves the data from LU 370 and sent it back to virtualization switch 330;
c) virtualization switch 330 generates the data packets (i.e., headers and data) to be transferred to host 320; and
d) upon completing the data transfer, virtualization switch 330 generates a response command signaling the end of the SCSI read command.

This approach is inefficient, since significant latency is added when data travels through two virtualization switches.

In one embodiment the disclosed invention provides an efficient method for data transmissions without transferring data between independent virtualization switches, i.e., between independent switches 330 and 340. In this embodiment a first virtualization switch (e.g., virtualization switch 330) provides a second virtualization switch (e.g., virtualization switch 340) with the list of headers to be included in the transmitted packets. The second virtualization switch, retrieves the data from the designated LUs, reconstructs data packets, i.e., adds the data to the headers and sends the data packets directly to the initiator host.

FIG. 4 shows an exemplary data packet with the required headers prior to being transmitted over the network. The SCSI commands and the requested data are first broken up into data packets. Added to each data packet 440 are: an iSCSI header 430, a TCP header 420, and an IP header 410. The iSCSI header 430 that defines the SCSI command is created either by an iSCSI initiator or a SCSI target. Typically, the SCSI headers, that define a SCSI command, are created by the initiator. Headers that describe the results of the command are generated by the target. While the iSCSI header 430 is the storage-related portion of the packet, other headers provide information necessary for carrying out normal networking functions. The IP header 410 provides packet routing information used for moving the messages across the network. The TCP header 420 contains the identification and control data needed to guarantee message delivery to a desired destination. It should be noted that the iSCSI header 430 can be placed in different positions within the TCP packet. It should be further noted that an iSCSI protocol data unit (PDU) (e.g., data packet 440) can be broken up into multiple packets each containing an Ethernet header, an IP header, and a TCP header, while only the first PDU packet includes also the iSCSI header. The headers provided by the first virtualization switch already include the information related to the first virtualization switch. This information comprises of at least IP address, TCP connection, and port number of the first virtualization switch as well as to the sequential number of the data packets. By providing the second virtualization switch with packet headers that include information related to the first virtualization switch, the initiator host treats the received data packets as they were transmitted by the first virtualization switch.

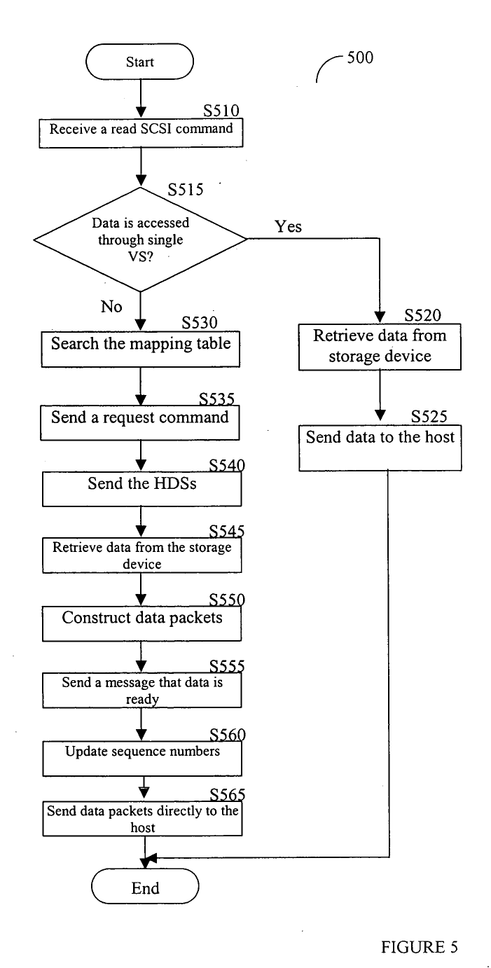

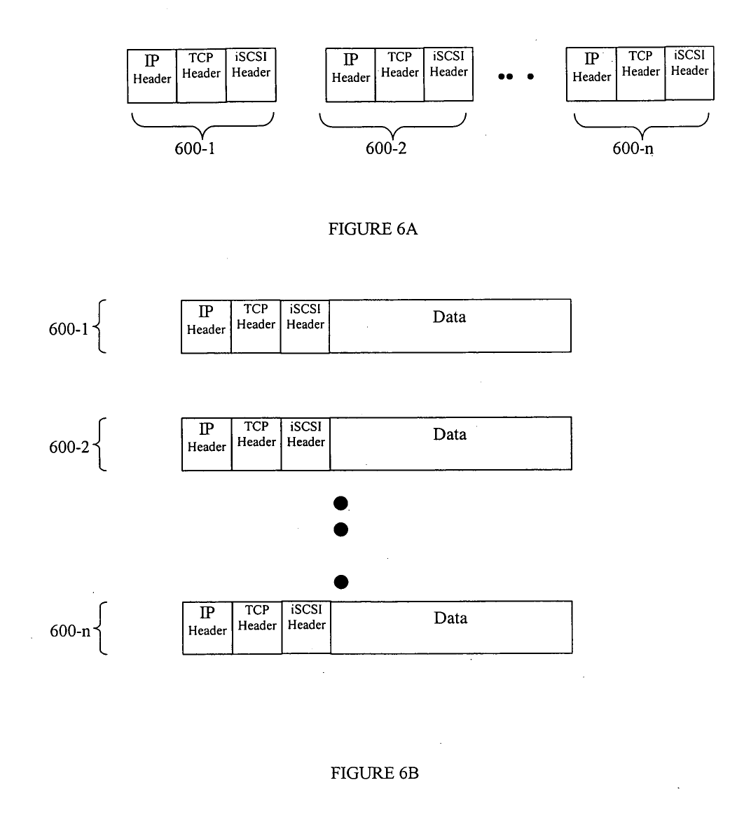

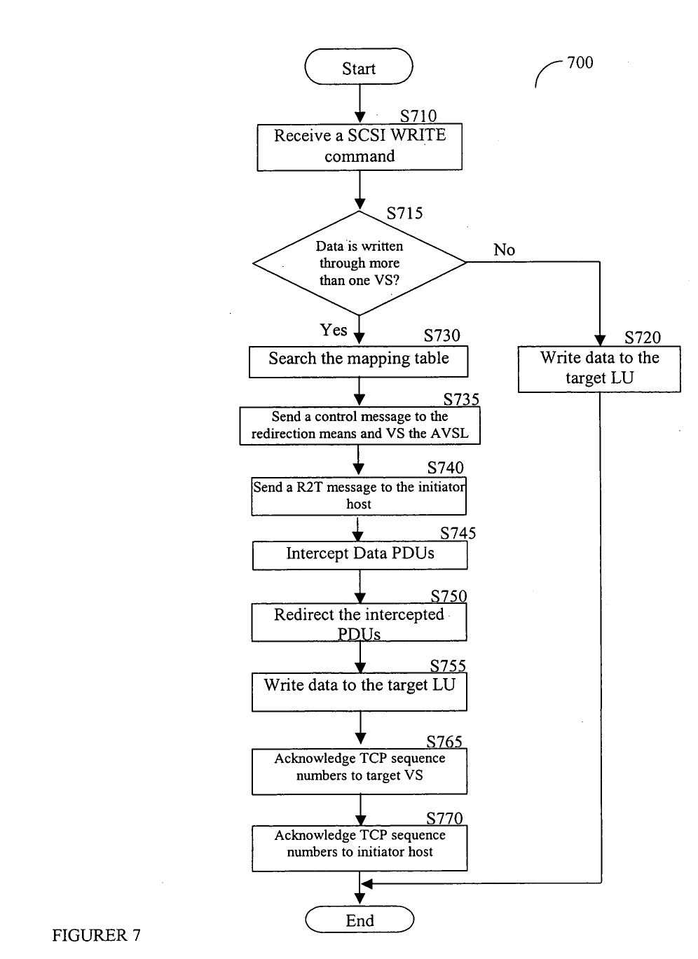

Referring to FIG. 5 a non-limiting and exemplary flowchart 500 describing the method for reading data spread over a plurality of independent storage networks is shown. The method allows the sending of data directly to an initiator host without transferring data between virtualization switches. At step S510, a target virtualization switch 210-i receives a SCSI READ command sent from an initiator host, for example, one of hosts 220. A target virtualization switch is defined as the virtualization switch that receives the incoming SCSI command. The target virtualization switch 210-i parses the incoming SCSI command to determine the type of the command, its validity, the target LU, and the number of bytes to be read. At step S515, a check is performed to determine if the entire data requested to be read resides in the LU designated in the incoming command. Namely, it is checked whether the requested data can be retrieved only through the target virtualization switch 210-i. If so, execution continues with step S520, where the data is retrieved through the target virtualization switch 210-i and then, at step S525, the data is sent to initiator host 220; otherwise, execution continues with step S530. At step S530, the target virtualization switch 210-i searches the mapping table for a list of virtualization switches 210 that have access to LUs, which include part or the entire data to be read. This list is referred to hereinafter as the “access virtualization switch list” (AVSL). At step S535, the target virtualization switch 210-i sends to each virtualization switch 210 in the AVSL a request to prepare the required data. Subsequently, at step S540, the target virtualization switch 210-i provides each virtualization switch 210 in the AVSL with a header data structure (HDS). The HDSs are sent simultaneously to virtualization switches 210 in the AVSL. A HDS includes instructions for the reconstruction of the TCP packets and iSCSI PDUs. Specifically, a HDS comprises a list of headers' groups, each containing an iSCSI header 430, a TCP header 420, and an IP header 410. FIG. 6A shows an exemplary representation of a HDS that includes ‘n’ groups of headers 600-1 through 600-n. The number of groups equals to the number of data packets required to be retrieved through a virtualization switch 210-j. The headers 610-1 through 610-n include the IP address, the TCP connection, and port number of the target virtualization switch 210-i as well as the iSCSI state.

At step S545, a virtualization switch 210-j, found in the AVSL, retrieves the requited data blocks from the target LU. At step S550, for each data block a corresponding group of headers in the HDS, for example, one of headers 600-1 through 600-n, is added. FIG. 6B shows the complete data packets, i.e., packets that include the header and data to be sent to the initiator host. At step S555, virtualization switch 210-j informs the target virtualization switch 210-i that data is ready. As a result, at step S560, virtualization switch 210-i sends the TCP and iSCSI sequence numbers to virtualization switch 210-j. The TCP and iSCSI sequence numbers are respectively written to the TCP header and iSCSI header. Upon reception of the sequence numbers virtualization switch 210-j updates the TCP and iSCSI headers received as part of the HDS. At step S565, the updated data packets are sent directly from the virtualization switch 210-j to the initiator host. In addition, an acknowledgment is sent to the target virtualization switch 210-i. It should be noted that, when data packets are sent to the initiator host, at steps S520 and S565, the data packets are processed through all iSCSI layers as discussed in greater detail above.

It should be noted that if data has to be read through multiple virtualization switches in the AVSL, the target virtualization switch 210-i sends a request to prepare the required data to each of those virtualization switches simultaneously. However, the target virtualization switch 210-i instructs (by sending the sequence numbers) each time a single virtualization switch in the AVSL to send the data to the initiator host. Once the entire requested data was read, a response command is sent to the initiator host. In the response command the target virtualization switch returns the final status of the operation including any errors if such have occurred.

Referring to FIG. 7, a non-limiting and exemplary flowchart 700 describing the method for writing data to a plurality of LUs connected to a plurality of independent storage networks is shown. The method allows an initiator host to send data directly to a target virtualization switch without transferring the data between virtualization switches. For this purpose a virtualization switch should include redirection means or be connected to a network device, for example, an Ethernet switch, having such means. Specifically, the redirection means performs the following: a) tracks the iSCSI PDU boundaries per each TCP connection that runs an iSCSI session; b) keeps, per TCP connection that runs an iSCSI session, multiple identification (ID) names IDs and their redirection destinations; and, c) splits a TCP packet, when parts of the packet belongs to different destinations.

At step S710, a target virtualization switch 210-i receives a SCSI WRITE command sent from an initiator host (e.g., one of hosts 220). A target virtualization switch is defined as the virtualization switch that receives the incoming SCSI command. The target virtualization switch 210-i parses the incoming SCSI command to determine the type of the command, the validation of the command, the target LU, and the number of bytes to be written. At step S715, a check is performed to determine if the data requested to be written, has to be transferred through virtualization switches other than the target virtualization switch 210-i. If step S715 yields a ‘no’ answer, then execution continues with step S720 where the data is sent directly from the initiator host to the designated LU through the target virtualization switch 210-i; otherwise, execution continues with step S730. At step S730, the target virtualization switch 210-i searches the mapping table for a list of virtualization switches 210 (i.e., the AVSL) that have access to LUs in which part, or the entire data, has to be written. At step S735, the target virtualization switch 210-i sends a control message to the redirection means, and to each of virtualization switches 210 in the AVSL. This control message instructs the redirection means to redirect all data PDUs, received from the initiator host, that have an ID name that equals the target task tag (TTT) assigned to the redirection means. The control message further informs virtualization switch 210-j, found in the AVSL, to be ready to receive the Data PDUs. Generally, the TTT is a field in a ready-to-transfer (R2T) message. The R2T is an iSCSI message sent by the target that informs the initiator that it is allowed to send data, within data PDUs, for an ongoing SCSI WRITE command. The R2T includes the logical offset, from the beginning of the command, and the length that the initiator should send. The TTT is a 32-bit value that the target places in the R2T message. The initiator attaches the TTT value in every data PDU sent for this R2T. At step S740, for each virtualization switch in the AVSL, the target virtualization switch 210-i sends a R2T message to the initiator host. The TTT in the R2T is the ID name of the redirection means. At step S745, data PDUs are sent to virtualization switch 210-i with the TTT included in the R2T are intercepted by the redirection means. At step S750, the redirection means redirects the data PDUs to virtualization switch 210-j. In addition, the redirection means forwards to the target virtualization switch 210-i only the headers of the PDUs. This is performed as virtualization switch 210-i may receive multiple PDUs on this TCP connection and may consider the initiator host as faulty due to missing PDUs and TCP sequence number gaps. At step S755, virtualization switch 210-j writes the data to the target LU and then, at step S760, sends to virtualization switch 210-i the TCP sequence numbers that were received as part of the PDUs. At step S765, virtualization switch 210-i acknowledges the TCP sequence numbers to the initiator host and the redirection means, i.e., acknowledges the writing of PDUs related to receive TCP sequence numbers. As a result, the redirection means removes the redirection rule associated with the current SCSI WRITE command. At step S770, once the entire data is written to all virtualization switches 210 designated in the AVSL, the target virtualization switch 210-i sends a SCSI response to the initiator host. It should be noted that writing data to multiple virtualization switches in the AVSL (i.e., steps S750 through S765) is performed in parallel.

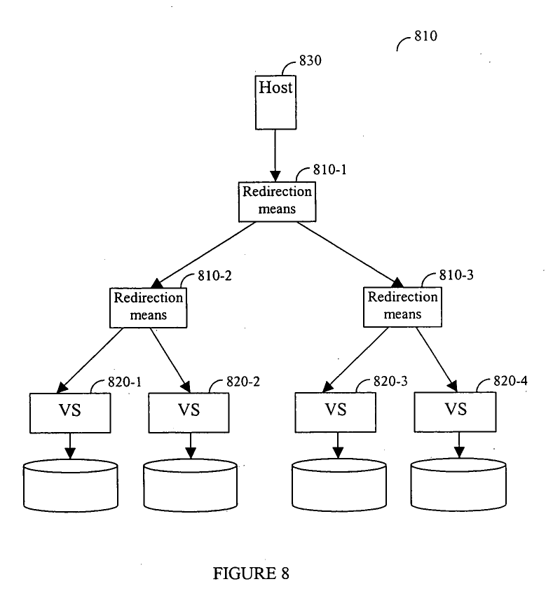

In an embodiment of this invention the redirection means mentioned above can replaced by the Ethernet switches in the SAN. In such a configuration the redirection means further serves as an Ethernet switch for all the virtualization switches in the SAN. Such configuration also allows for easy scaling of the SAN system. An example for a scalable topology is shown in FIG. 8. Redirection means 810-1 is connected to redirection means 810-2 and 810-3 in order to handle virtualization switches 820-1 through 820-4.

Redirection means 810-1 redirects the data PDUs when the initiator host 830 writes to a storage location handled by virtualization switches 820-1 and 820-2. Similary, redirection means 810-2 redirects the data PDUs when initiator host 830 writes to a storage location handled by virtualization switches 820-3 and 810-4.

In another embodiment of the invention the redirection means is embedded in the virtualization switch. In this configureation, a network processor unit (NPU) operates in conjunction with the virtulization switch, processing Ethernet frames as these frames flow through the switch.

1. A methodfor sharing data between a plurality of independent virtualization switches, wherein said method is capable of reading data spread over storage devices connected to said plurality of independent virtualization switches, the method comprises the steps of:
receiving a read command sent from an initiator host to a target virtualization switch;
searching for a list of virtualization switches that have access to one or more logical units (LUs), wherein each of said LUs include part or the entire data to be read;
sending to each of the virtualization switches in said list a request to prepare the required data;
sending to each of the virtualization switches in said list a data header data structure (HDS);
iteratively, each of the virtualization switches in said list performs:
retrieving a data block from al least one of said LUs;
constructing at least one data packet from the retrieved block;
informing said target virtualization switch that data is ready;
updating the reconstructed data packet with sequence numbers received from said target virtualization; and,
sending the reconstructed data packet to said initiator host.

2. The method of claim 1, wherein said read command is a read small computer system interface (SCSI) command.

3. The method of claim 2, wherein said read SCSI command is sent from initiator host to the virtualization switch by means of at least an internet small computer system interface (iSCSI) protocol.

4. The method of claim 3, wherein said HDS comprises at least a list of groups of headers.

5. The method of claim 4, wherein each of said groups of headers comprises at least: an iSCSI header, a transmission control protocol (TCP) header, an internet protocol (IP) header.

6. The method of claim 5, wherein the step of constructing said data packet comprises attaching a group of headers to said retrieved data packet.

7. The method of claim 1, wherein the step of searching for said list of virtualization switches is performed using a mapping table maintained by said target virtualization switch.

8. The method of claim 7, wherein said mapping table includes at least mapping information specifying virtualization address spaces accessed by each of said plurality of independent virtualization switches.

9. The method of claim 1, wherein said sequence numbers are at least one of: TCP sequence numbers, iSCSI sequence numbers.

10. The method of claim 1, wherein the step of updating said reconstructed data packet further comprises updating the headers of said reconstructed data packet with said TCP sequence numbers and said iSCSI sequence numbers.

11. The method of claim 1, wherein said method further comprises the step of:
sending a response command to said initiator host upon completing the transfer of the required data.

12. The method of claim 1, wherein each of said plurality of independent virtualization switches is connected in an independent cluster of virtualization switches.

13. A computerprogram product, comprising a computer-readable medium with instructions to enable a computer to implement a process for sharing data between a plurality of independent virtualization switches, wherein said process is capable of reading data spread over storage devices connected to said plurality of independent virtualization switches, the process comprises the steps of:
receiving a read command sent from an initiator host to a target virtualization switch;
searching for a list of virtualization switches that have access to one or more logical units (LUs), wherein each of said LUs include part or the entire data to be read;
sending to each of the virtualization switches in said list a request to prepare the required data;
sending to each of the virtualization switches in said list a data header data structure (HDS);
iteratively, each of the virtualization switches in said list performs:
retrieving a data block from al least one of said LUs;
constructing at least one data packet from the retrieved block;
informing said target virtualization switch that data is ready;
updating the reconstructed data packet with sequence numbers received from said target virtualization; and,
sending the reconstructed data packet to said initiator host.

14. The computer program product of claim 13, wherein said read command is a read small computer system interface (SCSI) command.

15. The computer program product of claim 14, wherein said read SCSI command is sent from initiator host to the virtualization switch by means of at least an internet small computer system interface (iSCSI) protocol.

16. The computer program product of claim 15, wherein said HDS comprises at least a list of groups of headers.

17. The computer program product of claim 16, wherein each of said groups of headers comprises at least: an iSCSI header, a transmission control protocol (TCP) header, an internet protocol (IP) header.

18. The computer program product of claim 17, wherein the step of constructing said data packet comprises attaching a group of headers to said retrieved data packet.

19. The computer program product of claim 13, wherein the step searching for of said list of virtualization switches is performed using a mapping table maintained by said target virtualization switch.

20. The computer program product of claim 19, wherein said mapping table includes at least mapping information specifying virtualization address spaces accessed by each of said plurality of independent virtualization switches.

21. The computer program product of claim 13, wherein said sequence numbers are at least one of: TCP sequence numbers, iSCSI sequence numbers.

22. The computer program product of claim 13, wherein the step of updating said reconstructed data packet further comprises updating the headers of said reconstructed data packet with said TCP sequence numbers and said iSCSI sequence numbers.

23. The computer program product of claim 13, wherein said method further comprises the step of:
sending a response command to said initiator host upon completing the transfer of the required data.

24. The computer program product of claim 13, wherein each of said plurality of independent virtualization switches is connected in an independent cluster of virtualization switches.

25. A method for sharing data between a plurality of independent virtualization switches, wherein said method is capable of writing data spread over storage devices connected to said plurality of independent virtualization switches, the method comprises the steps of:
receiving a write command sent from an initiator host to a target virtualization switch;
searching for a list of virtualization switches that have access to one or more logical units (LUs), wherein each of said LUs include part or the entire data to be written;
sending a control message to a redirection means and to each of the virtualization switches in said list;
sending a ready-to-transmit message from said target virtualization switch to said initiator host;
intercepting data protocol data units (PDUs) sent to said target virtualization from said initiator host;
forwarding each of the intercepted data PDUs to one of the virtualization switches in said list that has access to a target LU that the handed said intercepted data PDU;
writing said intercepted data PDU to said target LU; and,
sending an acknowledgment to said initiator host and said redirection means.

26. The method of claim 25, wherein said write command is a write small computer system interface (SCSI) command.

27. The method of claim 26, wherein said control message instructs the redirection means to redirect the data PDUs with identification (ID) name equals to a target task tag (TTT) value assigned to said redirection means.

28. The method of claim 27, wherein said control message further informs the virtualization switches in said list to be ready to receive said data PDUs.

29. The method of claim 27, wherein said TTT value is part of a ready-to-transmit message.

30. The method of claim 29, wherein said TTT's value is assigned by said target virtualization switch.

31. The method of claim 25, wherein the step of searching for said list of virtualization switch in said list is performed using a mapping table.

32. The method of claim 25, wherein said mapping table includes at least mapping information specifying virtualization address spaces accessed by each of said plurality of independent virtualization switches.

33. The method of claim 25, wherein the step of forwarding said intercepted data further comprises the step of:
forwarding at least headers of said data PDUs to said target virtualization switch.

34. The method of claim 33, wherein said headers of the data PDUs include at least TCP sequence numbers.

35. The method of claim 34, wherein the step of writing said data PDU further comprises the step of:
sending to said target virtualization switch TCP sequence numbers associated with said data PDU.

36. The method claim 25, wherein the step of sending acknowledgment to said redirection means further comprises:
removing from said redirection means a redirection rule associated with said write command.

37. The method of claim 25, wherein said method further comprises the step of:
sending a response command from said target virtualization switch to said initiator host upon writing the entire data.

38. The method of claim 25, wherein said redirection means is embedded in each of said independent virtualization switches.

39. The method of claim 38, wherein said redirection means is embedded in a network device connected to a virtualization switch.

40. The method of claim 39, wherein said network device is at least an Ethernet switch.

41. The method of claim 25, wherein said independent virtualization switches are part of independent storage area networks.

42. The method of claim 41, wherein each of said plurality independent virtualization switches is connected in an independent cluster of virtualization switches.

43. A computer program product, comprising a computer-readable medium with instructions to enable a computer to implement a process for sharing data between a plurality of independent virtualization switches, wherein said method is capable of writing data spread over storage devices connected to said plurality of independent virtualization switches, the method comprises the steps of:
receiving a write command sent from an initiator host to a target virtualization switch;
searching for a list of virtualization switches that have access to one or more logical units (LUs), wherein each of said LUs include part or the entire data to be written;
sending a control message to a redirection means and to each of the virtualization switches in said list;
sending a ready-to-transmit message from said target virtualization switch to said initiator host;
intercepting data protocol data units (PDUs) sent to said target virtualization from said initiator host;
forwarding each of the intercepted data PDUs to one of the virtualization switches in said list that has access to a target LU that the handed said intercepted data PDU;
writing said intercepted data PDU to said target LU; and,
sending an acknowledgment to said initiator host and said redirection means.

44. The computer program product of claim 42, wherein said write command is a write small computer system interface (SCSI) command.

45. The computer program product of claim 44, wherein said control message instructs the redirection means to redirect the data PDUs with identification (ID) name equals to a target task tag (TTT) value assigned to said redirection means.

46. The computer program product of claim 45, wherein said control message further informs the virtualization switches in said list to be ready to receive said data PDUs.

47. The computer program product of claim 45, wherein said TTT value is part of a ready-to-transmit message.

48. The computer program product of claim 47, wherein said TTT's value is assigned by said target virtualization switch.

49. The computer program product of claim 43, wherein the step of searching for said list of virtualization switch is performed in a mapping table maintained by said target virtualization switch.

50. The computer program product of claim 43, wherein said mapping table includes at least mapping information specifying virtualization address spaces accessed by each of said plurality of independent virtualization switches.

51. The computer program product of claim 43, wherein the step of forwarding said intercepted data further comprises the step of:
forwarding at least headers of said data PDUs to said target virtualization switch.

52. The computer program product of claim 51, wherein said headers of the data PDUs include at least TCP sequence numbers.

53. The computer program product of claim 52, wherein the step of writing said data PDU further comprises the step of:
sending to said target virtualization switch TCP sequence numbers associated with said data PDU.

54. The computer program product claim 43, wherein the step of sending acknowledgment to said redirection means further comprises:
removing from said redirection means a redirection rule associated with said write command.

55. The computer program product of claim 43, wherein said method further comprises the step of:
sending a response command from said target virtualization switch to said initiator host upon writing the entire data.

56. The computer program product of claim 43, wherein said redirection means is embedded in each of said independent virtualization switches.

57. The computer program of claim 56, wherein said redirection means is embedded in a network device connected to a virtualization switch.

58. The computer program product of claim 57, wherein said network device is at least an Ethernet switch.

59. The computer program product of claim 43, wherein said independent virtulization switches are part of independent storage are networks.

60. The computer program product of claim 59, wherein each of said plurality of independent virtualization switches is connected in an independent cluster of virtualization switches.
